(19) United States
(12) Patent Application Publication
(10) Pub. No.: US 2010/0302455 A1
(43) Pub. Date: Dec. 2, 2010

(54) Source Device Selecting Apparatus

(75) Inventors: Hirochika MAEGAKI, Hamamatsu-shi (JP); Yuki Yoshizawa, Hamamatsu-shi (JP); Katsuaki Tanaka, Hamamatsu-shi (JP)

Correspondence Address: CROWELL & MORING LLP;INTELLECTUAL PROPERTY GROUP, P.O. BOX 14300, WASHINGTON, DC, 20044-4300, US

(73) Assignee: Yamaha Corporation, Hamamatsu-shi (JP)

(21) Appl. No.: 12/787,776

(22) Filed: May 26, 2010

(30) Foreign Application Priority Data
May 26, 2009 (JP) 2009-127077

(51) Int. Cl. H04N 5/268

(52) U.S. Cl. 348/706; 348/E05.057

(57) ABSTRACT

A source device selecting apparatus includes: a plurality of connecting sections; a candidate device storing section for storing source devices that are connectable to the connecting sections and watching/listening modes of the contents that the respective source devices can reproduce; a selection accepting section that displays a list of the source devices to accept a user's choice, and displays a list of the connecting sections to accept a user's choice; and a connecting device storing section for storing a correspondence among the source device, the connecting section and the watching/listening modes. The apparatus further includes: a watching/listening mode selecting section; a reproducing device selecting section that displays a list of the source devices corresponding to the selected watching/listening mode to accept a user's choice; and a connection switching section that connects the selected connecting section to the outputting section.

### BACKGROUND OF THE INVENTION

1. Technical Field

The present invention relates to a source device selecting apparatus capable of facilitating the connection and the selection of a plurality of source devices.

2. Background Art

The custom installation used to construct the AV system by freely combining a plurality of AV (audio/video) devices is widely adopted. In the custom installation, in order to select freely the desired content out of a wide variety of audio/video contents from a plurality of connected source devices and reproduce it, the AV receiver is employed (see Non-Patent Literature 1, for example).
Non-Patent Literature 1: Yamaha Corporation of America, “RX-V/RX-Z/RX-N Series, AV Receivers from Yamaha Electronics”, [online], 2009, Yamaha Corporation of America, [May 15, 2009 searched], Internet <URL: www.yamaha.com/yec/products/productdetail.html?CNTID=558249&CTID=5000300>

Many types of devices such as an STB (Set-Top Box), a DVD player, a VCR (Video Cassette Recorder) deck, and the like are connected as the source device.

The output formats of the image signals and the sound signals in a plurality of source devices are different. Even in the same type source devices (e.g., the DVD players), the output formats of signal are not identical depending on the manufacturer, the model, and the like. For example, there are the analog output, the digital optical output, the coaxial output, etc. in the case of the sound signal, while there are the digital HDMI output (including the sound signal), the analog component output, the composite output, etc. in the case of the image signal. Also, the different interface (connector) is needed for each output format.

As the conventional AV receiver, there are (1) the AV receiver in which one type of connector is assigned fixedly to one type of source device, (2) the AV receiver equipped with all types of connectors for respective source devices, and others.

In the apparatus in the above mode (1), the inputs are fixed for each source device and there is no flexibility in connection. Therefore, the choice of the source devices is subject to constraints. In the apparatus in the above mode (2), a variety of connectors must be provided to respective source devices. Therefore, the back surface of the apparatus is occupied by many connectors and the connecting operation is troublesome, and also these connectors impede a size reduction.

### SUMMARY OF THE INVENTION

It is an object of the present invention to provide a source device selecting apparatus that makes it possible to connect a plurality of source devices effectively, and facilitates a setting operation of the connections.

There is provided a source device selecting apparatus, including: a plurality of connecting sections to be connected to respective source devices, each device outputting at least one of an image signal and a sound signal and reproducing at least a part of plural types of contents whose watching/listening modes are different from each other; an outputting section that is configured to output the image signal or the sound signal being input from the connecting sections; a candidate device storing section for storing source devices that are connectable to the connecting sections and including a watching/listening mode table for storing the watching/listening modes of the contents that the respective source devices can reproduce; a selection accepting section that is configured to display a list of the source devices stored in the candidate device storing section, to accept a selection of any one of the displayed source devices, to display a list of the connecting sections, and to accept a selection of the displayed connecting sections to be connected to the selected source device; a connecting device storing section for storing a correspondence among the source device and the connecting section which are selected by the selection accepting section, and the watching/listening modes stored in the candidate device storing section; a watching/listening mode selecting section that is configured to accept a user's choice of the watching/listening mode; a reproducing device selecting section that is configured to display a list of the source devices stored in the connecting device storing section and corresponding to the selected watching/listening mode to accept a selection of any one of the source devices; and a connection switching section that is configured to search the connecting section to which the source device selected by the reproducing device selecting section is connected, from the connecting device storing section, and to connect the searched connecting section to the outputting section.

The source device selecting apparatus may be configured in that the plurality of connecting sections include an image signal connecting section for receiving the image signal, a sound signal connecting section for receiving the sound signal, and a composite connecting section for receiving both the image signal and the sound signal, the source device selecting apparatus further comprises a combination storing section for storing a combination of the image signal connecting section, the sound signal connecting section, or the composite connecting section, which are used in connecting one source device, and the selection accepting section displays a list of combinations stored in the combination storing section, as the list of the connecting sections.

The source device selecting apparatus may be configured in that the selection accepting section omits a combination containing the connecting section that is already stored in the connection device storing section from displaying the list of combinations.

The source device selecting apparatus may be configured in that the watching/listening modes include Listen mode, Watch mode and Play mode.

According to the present invention, the correspondences among the source devices, the connecting sections and the watching/listening modes are stored in the connecting device storing section. Then, when the source device is selected, the connecting section to which the concerned source device is connected is searched from the connecting device storing section, and then the connection is switched. Therefore, a wide variety of source devices can be connected effectively by the fewer connecting sections. Also, when the user selects the source device, the connecting section to which the source device is connected is selected.

Also, the registration of the connection of the source device is accepted in accordance with such procedures that a list of the source devices is displayed to accept any one selection of the source device, and then a list of the connection sections is displayed to accept a choice of the connecting section to which the selected source device is to be connected. Therefore, the connection of the device can be easily registered even by the inexpert user.

### BRIEF DESCRIPTION OF THE DRAWINGS

In the accompanying drawings:

FIG. 1 is a configurative view of an AV system containing an AV receiver as an embodiment of the present invention;

FIG. 2 is a block diagram of the AV receiver;

FIG. 3 is a rear view of the AV receiver;

FIG. 4 shows a connector selecting table stored in the AV receiver;

FIG. 5 shows a candidate device table stored in the AV receiver;

FIG. 6 shows a connecting device table stored in the AV receiver;

FIG. 7 is a flowchart showing an operation of a control unit of the AV receiver upon connecting the source device;

FIGS. 8A and 8B show an example of a TV display upon connecting the source device;

FIG. 9 is a flowchart showing an operation of a control unit of the AV receiver upon reproducing the content; and

FIGS. 10A to 10C show a TV display upon reproducing the content.

### DETAILED DESCRIPTION OF THE EXEMPLARY EMBODIMENTS

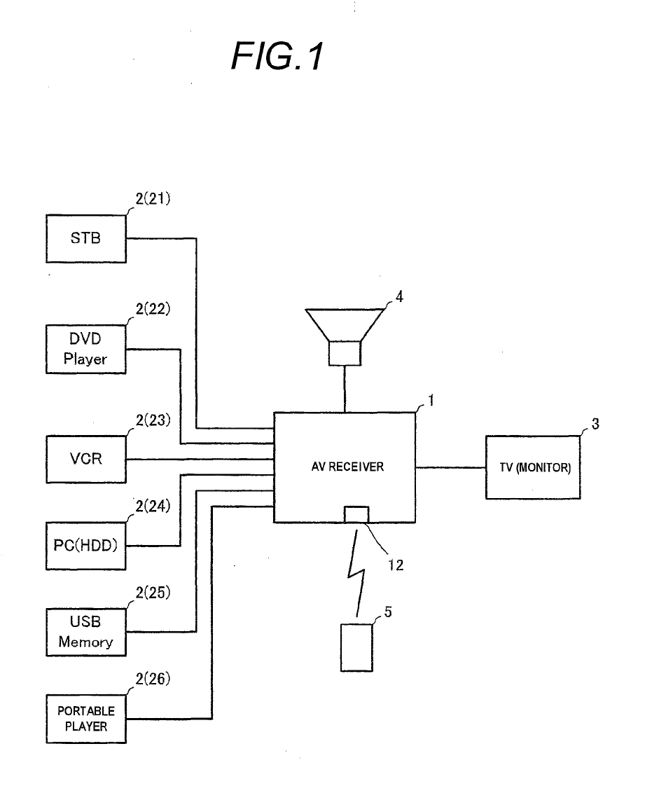

FIG. 1 is a configurative view of an AV system containing an AV receiver 1 as an embodiment of the present invention. This AV system is the so-called custom installation AV system in which a plurality of source devices 2, a TV (monitor) 3, a speaker 4 are connected to an AV receiver 1.

The AV receiver 1 includes a selector function of connecting a plurality of source devices 2 and selecting one device from a plurality of source devices 2, an audio amplifier function of amplifying an audio signal being input from the selected source device 2 and outputting the amplified signal to the speaker 4, a repeater function of outputting the image signal and the audio signal being input from the source devices 2 to the TV 3 on the downstream side, a tuner function of receiving the radio broadcast such as the FM broadcast, or the like, a commander function of controlling the source devices 2 and the TV 3 in response to the user's operation, and the like.

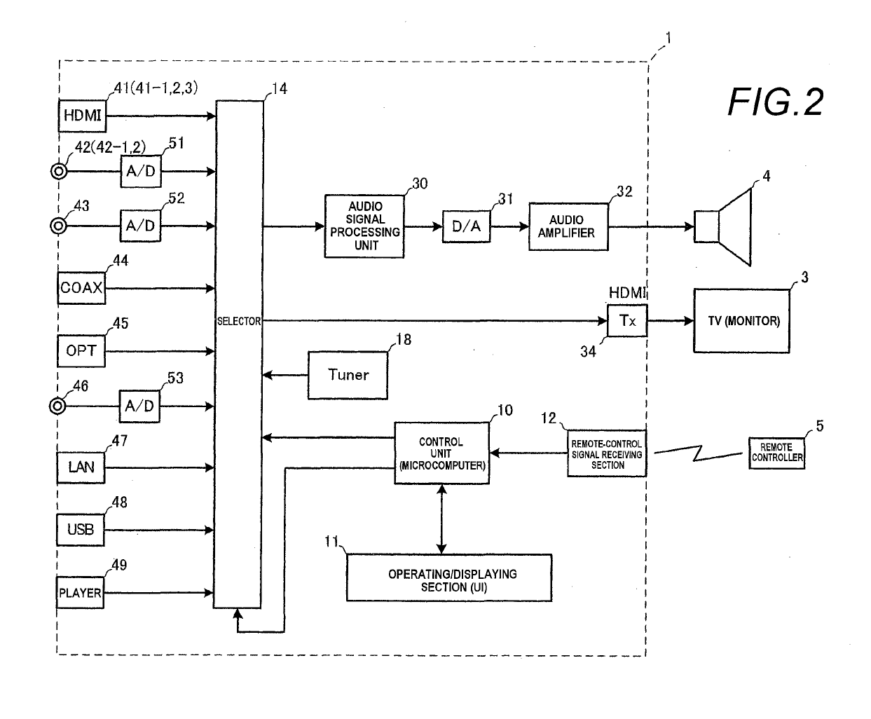

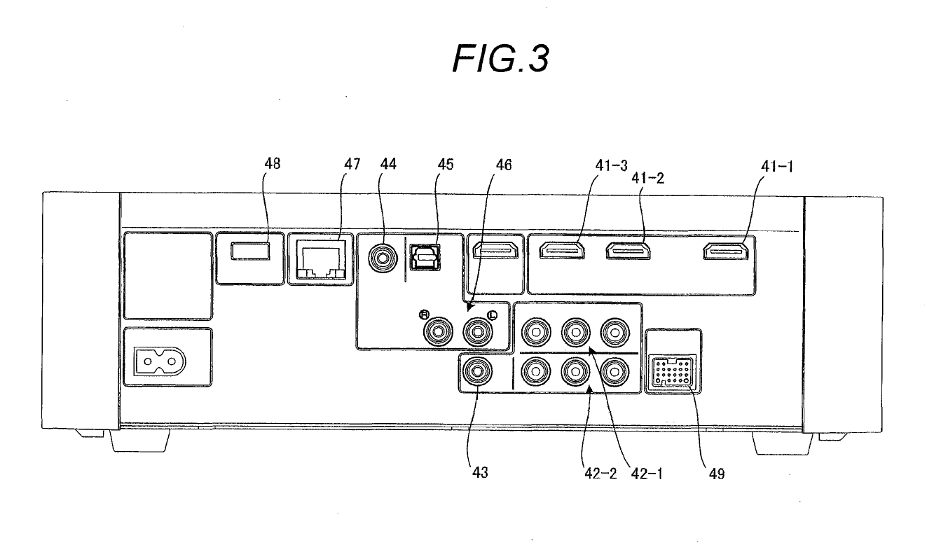

As the source devices 2 connected to the AV receiver 1 as the upstream side devices, there are an STB (set top box) 21, a DVD player 22, a VCR (video cassette recorder) 23, a personal computer (PC) 24, a USB memory 25, a portable player 26, and the like, for example. The STB 21 has a reproducing section for reproducing the television broadcast received via the cable or from the satellite. The DVD player 22 has a reproducing section for reproducing the disc that is set in the player. The VCR 23 has a reproducing section for playing the video cassette that is set in the deck. The PC 24 has a storing medium (HDD) for storing the audio contents, the video contents, etc., and is equipped with a reproducing section of reproducing these contents. The USB memory 25 has a storing medium for storing the contents such as the audio contents, and the like. Also, the portable player 26 has a storing medium (HDD or flash memory) for storing the audio contents, the video contents, etc., and is equipped with a reproducing function of reproducing these contents. Respective source devices 2 are connected to the connector shown in FIG. 2 and FIG. 3. The connections between respective connectors and the source devices 2 will be described later.

Also, the TV 3 connected as the downstream side device of the AV receiver 1 is used mainly as the monitor that displays the image being input from the AV receiver 1.

Also, the AV receiver 1 has a remote-control signal receiving section 12 that receives the infrared remote-control signal generated by a remote controller 5.

FIG. 2 is a block diagram of the AV receiver 1, and FIG. 3 is a rear view of the AV receiver 1. Various connectors used to connect a plurality of source devices 2 are provided to the back surface of the AV receiver 1. Here, it is assumed that respective connectors contain the electric circuit in the physical layer such as the transceiver, or the like.

As the connectors to which a plurality of source devices 2 are connected, HDMI connectors 41 (41-1, 41-2, 41-3) for receiving the digital image signal and the digital audio signal respectively, component connectors 42 (42-1, 42-2) for receiving the image signal as a luminance signal and a color-difference signal respectively, a composite connector 43 for receiving the image signal, a coaxial (Coax) connector 44 for receiving the digital audio signal, an optical (Opt) connector 45 for receiving the digital audio signal, and an analog connector 46 for receiving the analog audio signal are provided. All connector profiles of the component connectors 42, the composite connector 43, the coaxial connector 44, and the analog connector 46 are the RCA connector.

The STB 21, the DVD player 22, and the like are connected to the HDMI connectors 41. The analog VCR deck 23, etc., for example, are connected to the composite connector 43 and the analog connector 46.

Also, as dedicated connectors for a particular device, a LAN connector 47 connected to the PC 24 via the network, a USB connector 48 to which the USB memory 25 is connected, and a portable player connector 49 to which the dedicated bay for the portable player 26 is connected are connected.

Respective connectors are connected to the selector 14. In this case, the component connectors 42, the composite connector 43, and the analog connector 46 are connected to the selector 14 via A/D converters 51, 52, 52 as the analog input terminal respectively.

Also, a tuner 18 and a control unit 10 are connected to the selector 14 as the built-in source devices. The tuner 18 is the device that receives/reproduces the broadcasting sounds such as the FM broadcast, and the like. The control unit 10 is constructed by a microcomputer. This control unit 10 is equipped with a function of switching the selector 14, and a function of displaying OSD (On-Screen Display) such as various operation guides, set wizards, etc., and others and acts as the source device in displaying OSD.

The audio signal and the image signal or the video signal are input into the selector 14 from respective source devices 2. Here, the video signal denotes the signal containing both the image signal and the audio signal. The selector 14 outputs the audio signal of the selected device to an audio signal processing unit 30, and outputs the image signal (or the video signal) of the selected device to a HDMI transmitter 34. The TV 3 is connected to the HDMI transmitter 34 via the HDMI cable.

A tone quality, etc. of the audio signal is adjusted by the audio signal processing unit 30, and the adjusted signal is converted into the analog signal by a D/A converter 31. This analog signal is amplified by an audio amplifier 32, and then is input into the speaker 4. Here, when the audio amplifier 32 is composed of a digital amplifier, the D/A converter 31 is constructed by the circuit that converts the audio signal from the PCM (Pulse Code Modulation) code to the PWM (Pulse Width Modulation) signal.

The remote controller 5 has a power ON/OFF button of the AV receiver 1, a cursor button for moving a cursor displayed on the AV 3, and the like. When the user operates the button, the remote controller 5 generates the infrared remote-control signal in response to the operated button. The AV receiver 1 has the remote-control signal receiving section 12 for receiving the infrared signal generated by the remote controller 5. When the remote-control signal receiving section 12 receives the remote-control signal that the remote controller 5 generates, it analyzes the command code and input the analyzed result into the control unit 10. The control unit 10 executes the process corresponding to the command, e.g., the switching of the selector 14, based on the command code being input from the remote-control signal receiving section 12.

Here, the connections between the source devices 2 and respective connectors 41 to 46 will be explained hereunder. As shown in FIG. 3, three HDMI terminals 41 (HDMI 1, HDMI 2, HDMI 3), two component terminals 42 (Component 1, Component 2), the composite terminal 43 (Composite), the coaxial terminal 44 (Coaxial), the optical terminal 45 (Optical), and the analog audio terminal 46 (Analog) are provided to the AV receiver 1. These connectors are not correlated with particular source devices, and can be connected to any source device.

A combination of these connectors when the video signal (the image signal and the audio signal) is input by using these connectors is given by 12 ways as follows.

HDMI 1

HDMI 2

HDMI 3

Component 1+Coaxial

Component 1+Optical

Component 1+Analog

Component 2+Coaxial

Component 2+Optical

Component 2+Analog

Composite+Coaxial

Composite+Optical

Composite+Analog

Also, the connectors used to input the audio (sound) signal only are given by 3 ways as follows.

Coaxial

Optical

Analog

When the source device is connected to the connector in either of the combinations, the video signal and the audio signal can be input into the AV receiver 1 and can be selected by the selector 14. However, the user cannot know which source device has been connected to which connector in a situation that these connector 41 to 46 are set to “free-assign”. In contrast, it is common that the normal user selects the content of the input origin (source) by using not the name of the connector but the name of the source device.

Therefore, in the AV receiver 1, the source devices 2 and the connector 41 to 46 are correlated with each other by a connecting device table shown in FIG. 6. This correlation is given by the user's operation, and enables the inexpert user to do the connecting operation without mistake while displaying a procedure screen (wizard) in compliance with the procedures.

This wizard requests the user to select the source device, and then displays a list of the connectors (combinations of the connectors) to which the concerned source device can be connected. The user selects the connector, to which the source device is connected, from a list of the connectors. When a combination of the source devices and the connectors is selected, the user registers the combination of the selected source devices and the connectors in the connecting device table (see FIG. 6).

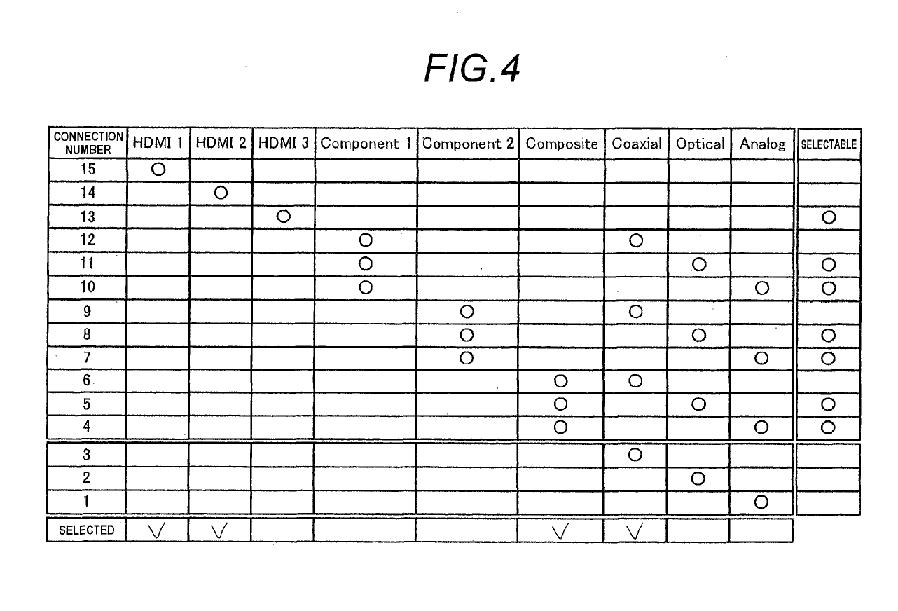

FIG. 4 shows the connector selecting table in which respective combinations of the connectors are stored. In this table, the combinations are identified by affixing the connection numbers 15 to 1. In this table, the connectors to which the source device has already been connected respectively (in-use connectors) are stored, and also the selectable combinations (the connection numbers) except the in-use connectors are stored.

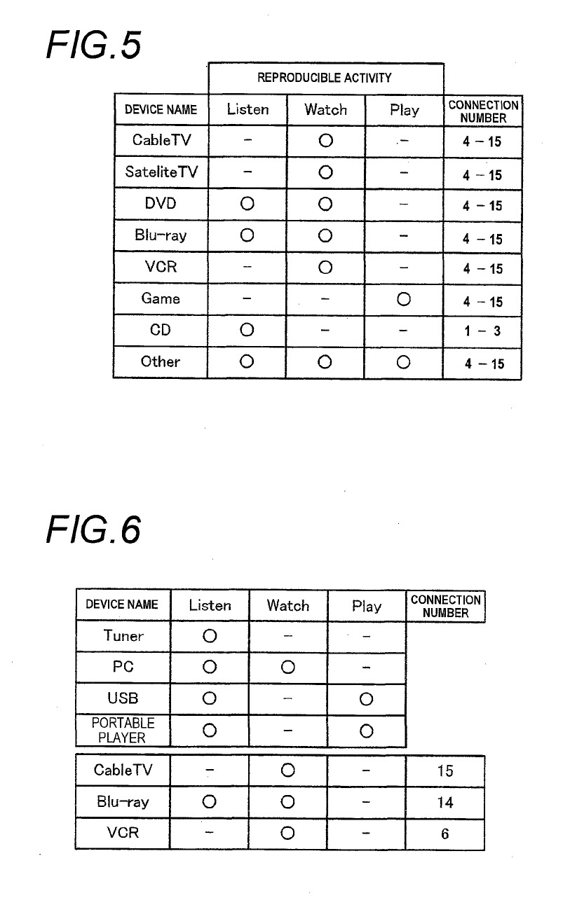

FIG. 5 shows a candidate device table in which the source devices that can be connected to the AV receiver 1 are stored. In this table, set top box for receiving the cable TV (Cable TV), set top box for receiving the satellite TV (Satellite TV), DVD player, Blu-ray player, video cassette deck (VCR), game machine (Game), CD player, and others (Other) are shown. The candidate devices are not limited to those shown in FIG. 5.

The “reproducible activity” shown in FIG. 5 are the information indicating the types of the contents that respective source devices can reproduce. In this AV receiver 1, the contents are classified into three types of contents (activities) of “Listen”, “Watch”, and “Play”. The term “Listen” shows the content in the watching/listening mode in which the user enjoys the content by listening it with user's own ears, and denotes the audio content. The term “Watch” shows the content in the watching/listening mode in which the user enjoys the content by watching it with user's own eyes, and denotes the video content. Also, the term “Play” shows the content in the watching/listening mode in which the user enjoys the content by operating it by himself or herself, and denotes the game or photo album (image) content, for example.

According to FIG. 5, the activity that the set top box for receiving the television broadcast via the cable broadcast or the satellite broadcast can reproduce is “Watch” only. Also, the activity that the DVD player can reproduce is “Watch” and “Listen”. That is, this is because not only the video contents (Watch) of the DVD such as the movie, and the like can be reproduced, but also the music contents (Listen) of the CD can be reproduced. This is true similarly of the Blu-ray player. Also, the VCR deck can reproduce “Watch” only, the game machine can reproduce “Play” only, and the CD can reproduce “Listen” only. Also, the other device can reproduce all activities of “Listen”, “Watch”, and “Play” since its reproducible activity is unclear.

The “connection number” in FIG. 5 indicates connection numbers of connectable connectors when the corresponding devices are selected.

Respective source devices 2 and the AV receiver 1 are connected by the connectors that can input/output the contents (activity) that the concerned source device reproduces respectively.

FIG. 6 shows the connecting device table. This connecting device table gives the table in which the source devices connected to the AV receiver 1 and the connectors that respective source devices employ are registered.

In FIG. 6, the cable TV (STB) is connected to the connection number 15, i.e., to the HDMI1 (41-1). The Blu-ray player is connected to the connection number 14, i.e., to the HDMI1 (41-2). Also, the VCR is connected to the connection number 6, i.e., to the Composite 43 and the Coaxial 44.

The content in the “selectable connector” column and the “selected connector” column of the connector selecting table in FIG. 4 show the contents when the connections in FIG. 6 are built up.

Here, out of the source devices that are registered in the connecting device table, the “Tuner” located in the uppermost row shows the built-in source device, and does not need the user's connecting operation. Also, the PC, the USB, and the portable player are connected to the dedicated connector respectively, and therefore the connection number is not affixed to them.

When the user connects the source device 2 to the AV receiver 1, the control unit 10 of the AV receiver 1 facilitates the connecting operation by displaying the wizard on the TV 3.

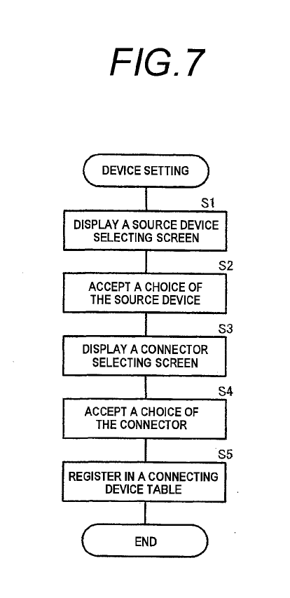

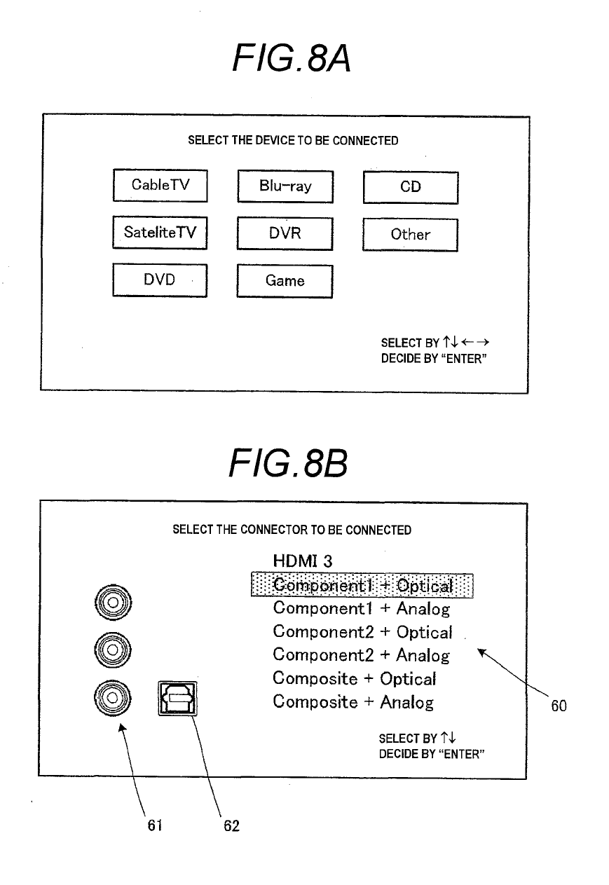

FIG. 7 is a flowchart showing processes of the control unit 10 when the source device is connected by the user, and FIGS. 8A and 8B show a display example on a screen of the TV 3 at that time.

In FIG. 7, when the operation to connect the source device is executed by the user, the AV receiver 1 switches the selector 14 to the control unit 10, and then executes the following operations. First, the AV receiver 1 reads the candidates of the source devices from the candidate device table in FIG. 5, and displays them on a selecting screen (S1). An example of the source device selecting screen is shown in FIG. 8A. The AV receiver 1 displays this source device selecting screen, and accepts a user's choice of the source device (S2). Then, when the source device is selected by the user, the AV receiver 1 displays candidates of connector combinations corresponding to the source device (S3). An example of the connector selecting screen is shown in FIG. 8B. As the display of the candidates of connector combinations, only the candidates of connector combinations that do not contain the connectors to which other devices have already been connected are displayed. Also, when the selected source device is the device used specially for the audio, the AV receiver 1 displays only the connection numbers 1 to 3 that do not contain the connectors for the image signal. When the candidates of connector combinations are displayed, the name 60 of the combinations and shapes 61, 62 of the connectors are shown as in FIG. 8B.

Then, the AV receiver 1 displays the connector selecting screen, and accepts a user's choice of the connector (connection number)(S4). When the connector is selected by the user, the AV receiver 1 registers the source device, the connection number, and the activity in the connecting device table in FIG. 6 (S5). Then, the process ends.

In this case, the user may carry out the connection of the source device to the selected connector in parallel with this process.

The correspondences among the source devices, the connectors 41 to 46 and the watching/listening modes are registered in the connecting device table by the above operations. Then, when the user wants to reproduce the content, first the user selects the activity, and then selects the desired source device from the source devices that can reproduce the activities displayed on the TV 3 in response to this selection.

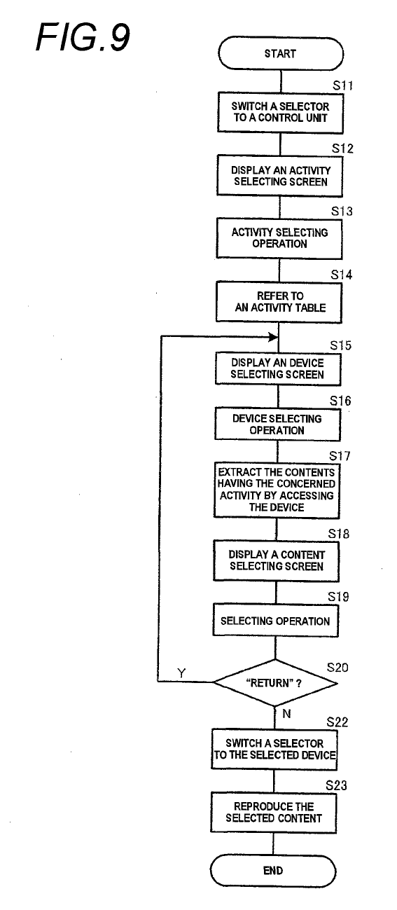

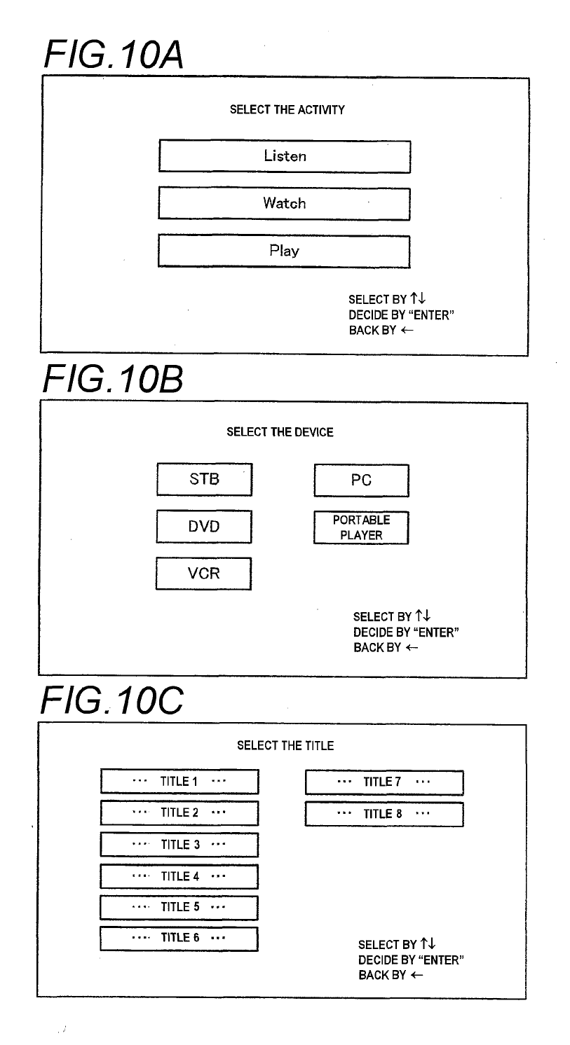

FIG. 9 is a flowchart showing an operation of the control unit 10 when the AV receiver starts to reproduce the content. FIGS. 10A to 10C show a display example of the screen of the TV 3 at that time.

When the operation to select the content is carried out by the user, first the AV receiver 1 switches the selector 14 to the control unit 10 (S11). This is because a following selecting screen should be displayed on the TV 3. Then, the control unit 10 causes the TV 3 to display an activity selecting screen shown in FIG. 10A (S12). The user selects the activity in response to this display (S13). When the activity selecting operation is done, the control unit 10 extracts the source device that can reproduce the selected activity, by referring to the connecting device table in FIG. 6 (S14). Then, the control unit 10 causes the TV 3 to display an device selecting screen (see FIG. 10B) from which the user selects the extracted source device (S15).

The user selects the source device in response to this display (S16). When the user's operation for selecting the source device is done, the control unit 10 accesses this source device, and then extracts the contents, which fit in with to the previously selected activity, out of the contents that this source device can reproduce (S17). Then, the control unit 10 causes the TV 3 to display a content selecting screen (see FIG. 10C) (S18). When the user selects the content in response to this display (S19), the AV receiver 1 switches the selector 14 to the selected device (S21), and then starts the reproduction of the selected contents (S22). This starting of content reproduction contains the operation that instructs the source device 2 to start the reproduction of the content, as well as the case where the AV receiver 1 itself reproduces the content (e.g., reads the MPEG2 file and decodes it).

In contrast, if the user does not select the content in the selecting operation in S19, but selects a “Return” operation (S20), the process goes back to the displaying operation of the source device selecting screen (S15).

In this embodiment, the AV receiver 1 is illustrated as the source device selecting apparatus. But the particular configuration of the source device selecting apparatus is not limited to the AV receiver.

What is claimed is:

1. A source device selecting apparatus, comprising:
a plurality of connecting sections to be connected to respective source devices, each device outputting at least one of an image signal and a sound signal and reproducing at least a part of plural types of contents whose watching/listening modes are different from each other;
an outputting section that is configured to output the image signal or the sound signal being input from the connecting sections;
a candidate device storing section for storing source devices that are connectable to the connecting sections and including a watching/listening mode table for storing the watching/listening modes of the contents that the respective source devices can reproduce;
a selection accepting section that is configured to display a list of the source devices stored in the candidate device storing section, to accept a selection of any one of the displayed source devices, to display a list of the connecting sections, and to accept a selection of the displayed connecting sections to be connected to the selected source device;
a connecting device storing section for storing a correspondence among the source device and the connecting section which are selected by the selection accepting section, and the watching/listening modes stored in the candidate device storing section;
a watching/listening mode selecting section that is configured to accept a user's choice of the watching/listening mode;
a reproducing device selecting section that is configured to display a list of the source devices stored in the connecting device storing section and corresponding to the selected watching/listening mode to accept a selection of any one of the source devices; and
a connection switching section that is configured to search the connecting section to which the source device selected by the reproducing device selecting section is connected, from the connecting device storing section, and to connect the searched connecting section to the outputting section.

2. The source device selecting apparatus according to claim 1, wherein the plurality of connecting sections include an image signal connecting section for receiving the image signal, a sound signal connecting section for receiving the sound signal, and a composite connecting section for receiving both the image signal and the sound signal,
the source device selecting apparatus further comprises a combination storing section for storing a combination of the image signal connecting section, the sound signal connecting section, or the composite connecting section, which are used in connecting one source device, and
the selection accepting section displays a list of combinations stored in the combination storing section, as the list of the connecting sections.

3. The source device selecting apparatus according to claim 2, wherein the selection accepting section omits a combination containing the connecting section that is already stored in the connection device storing section from displaying the list of combinations.

4. The source device selecting apparatus according to claim 1, wherein the watching/listening modes include Listen mode, Watch mode and Play mode.
